(19) United States
(12) Patent Application Publication
(10) Pub. No.: US 2023/0249151 A1
(43) Pub. Date: Aug. 10, 2023

(54) DEVICE FOR INSERTING A PACKING SECTION

(71) Applicant: L'Air Liquide, Societe Anonyme pour l'Etude et l'Exploitation des Procedes Georges Claude, Paris (FR)

(72) Inventors: Cyrille BABINET, Vitry sur Seine (FR); Eric GALLOPIN, Jouy-en-Josas (FR); Gilles LEBAIN, Vitry sur Seine (FR)

(73) Assignee: L'Air Liquide, Societe Anonyme pour l'Etude et l'Exploitation des Procedes Georges Claude, Paris (FR)

(21) Appl. No.: 18/106,982

(22) Filed: Feb. 7, 2023

(30) Foreign Application Priority Data
Feb. 8, 2022 (FR) FR 2201086

(51) Int. Cl. B01J 19/32

(52) U.S. Cl. CPC B01J 19/32; B01D 3/008

(57) ABSTRACT

The present invention relates to a device for inserting at least one packing section into a cylindrical shell, comprising a base provided with gripping means configured to grip hold of a packing section and arranged at regular intervals around a main axis, wherein the insertion device comprises at least two telescopic devices secured to the base and at least one pushing means secured to one end of each of the two telescopic devices, the telescopic devices being configured to extend and cause the pushing means to move.

### CROSS REFERENCE TO RELATED APPLICATIONS

This application claims the benefit of priority under 35 U.S.C. § 119 (a) and (b) to French patent application No. FR2201086, filed Feb. 8, 2022, the entire contents of which are incorporated herein by reference.

### FIELD OF THE INVENTION

The present invention relates to the field of gas/liquid separation columns and to their assembly and relates more particularly to a device for inserting packing sections for a gas/liquid separation column into a shell in order to form said gas/liquid separation columns.

### BACKGROUND OF THE INVENTION

Gas/liquid separation columns have been known for many years and can be used, for example, to separate different chemical elements present in the composition of a homogeneous fluid, for example by distillation or by absorption.

Manufacturing a gas/liquid separation column comprises, in particular, a step of inserting a plurality of packing sections into a shell. The packing sections are used in columns in particular to ensure the exchange of material and heat between a rising gas and a falling liquid. These packing sections, which consist, in particular, of several superposed corrugated strips, are often referred to as “packs”. The packing sections are conventionally stacked on each other, possibly with interposed separators, in order to help separate the components of the fluid along the axial dimension of the column.

Inserting packing sections for a gas/liquid separation column into a shell that is held vertical is known, the force of gravity greatly facilitating the insertion of the packing section into the shell. However, such a method can prove restrictive when the gas/liquid separation columns to be assembled have a large diameter and an axial dimension that requires long shells approximately several tens of metres in length to be used. Indeed, such methods in which the packing sections are inserted vertically require a tool capable of lifting the packing sections a long distance in order to bring them into line with the end of the shell and a production site with a ceiling higher than the length of the shell.

There is therefore a need, when long shells are used, for an assembly method in which the packing sections are inserted with the shell arranged horizontally. Such a position makes it difficult to insert the packing sections because this insertion requires a considerable pushing force along the whole length of the shell, with gravity no longer helping move the packing section into the shell. On the contrary, the force of gravity tends to press the packing section against a part of the shell, meaning that the frictional forces between the annular wall of the shell and the peripheral rim of the packing section are not uniform. This hinders the smooth linear insertion of packing section and can potentially damage the packing section while it is being inserted. Such stresses are particularly apparent when the packing sections and the shell have a diameter of several metres.

### SUMMARY OF THE INVENTION

In this context, certain embodiments of the present invention aim to facilitate the horizontal insertion of packing sections into a shell by proposing a device for inserting at least one packing section for a gas/liquid separation column into a cylindrical shell, comprising a base provided with gripping means configured to grip hold of a packing section and arranged at regular intervals around a main axis, characterized in that the insertion device comprises at least two telescopic devices secured to the base and at least one pushing means attached to one end of each of the two telescopic devices, the telescopic devices being configured to extend and cause the pushing means to move.

According to certain embodiments of the invention, the extension of the telescopic devices helps push the packing section for a gas/liquid separation column, and the plurality of these devices helps to create a uniform pushing force, preventing stress from building up locally due to the frictional forces as mentioned previously. The telescopic devices are configured to extend over a length substantially equal to the length of the shell, the length of extension and the length of the shell being considered here in a direction parallel to an axis of revolution of the shell.

According to certain embodiments of the invention, the pushing means is interposed between the end of the telescopic devices and the packing section. The pushing means helps to distribute the forces applied by the telescopic devices over the whole surface of said pushing means and therefore to increase the contact surface between the insertion device and the packing section that is being inserted. The presence of the pushing means therefore prevents forces from being applied directly to the packing section in an excessively local manner by the ends of the telescopic devices, which could damage the packing section.

The insertion device therefore helps pack a shell with a plurality of packing sections in order to form a separation column. The base of the insertion device, and more particularly the gripping means of the base, are suitable for gripping hold of a packing section by its sides. Since the packing sections are circular and may be up to 5 metres in diameter, the base needs to be dimensioned in such a way as to allow the gripping means to grip hold of such a packing section by the sides. The main axis around which the gripping means are arranged may, for example, pass through the centre of the packing section and/or be parallel to or coincide with the axis of revolution of the shell. Once the packing section is being gripped, it is positioned at the entrance of the shell, and the packing section can be pushed into the shell, via the telescopic devices.

There can be at least two telescopic devices, in order to avoid pushing the packing section at a single point at its centre, which would not allow effective compensation for the frictional forces applied to the periphery of the packing section by the wall of the shell. Advantageously, the insertion device comprises at least three telescopic devices distributed in such a way as to minimize the frictional forces applied to the packing section by the shell during the pushing operation. The insertion device according to the invention is thus suitable for pushing a packing section horizontally into a shell while minimizing the frictional forces applied to the packing section.

According to one feature of the invention, the telescopic devices are arranged at regular intervals around the main axis. Arranging the telescopic devices at regular intervals prevents unequal compensation of the frictional forces applied to the packing section as a whole.

According to one feature of the invention, the telescopic devices and the gripping means are arranged on a peripheral post of the base. The base may thus comprise a plurality of peripheral posts, all arranged at regular intervals around the main axis. A peripheral post may therefore carry a gripping means alone, a telescopic device alone, or indeed both at the same time, the essential point being that the gripping means and the telescopic device do not interfere with each other mechanically in a manner that could impair the correct operation of either or both components.

Like the telescopic devices, the gripping means are preferably distributed at regular intervals around the main axis, in order to hold the packing section securely and optimally.

According to one feature of the invention, each telescopic device has a pushing force of at least 1 ton. As previously mentioned, the packing sections have a diameter of up to 5 metres. Pushing packing sections of this size into the shell therefore requires a very high pushing force. The telescopic devices must therefore be capable of applying such a pushing force, preferably of between 1 ton and 1.5 tons.

According to one feature of the invention, the telescopic devices are controlled individually. Controlling each of the telescopic devices individually may prove useful, for example, when a frictional force applied to the packing section is locally higher. A pushing force may then be increased at the telescopic device closest to the frictional force in question in order to balance the forces during the insertion and optimize the insertion process. In order to determine whether there is an imbalance in the frictional forces, each of the telescopic devices may, for example, comprise a resistance sensor in order to measure the frictional forces and adjust the pushing force of each of the telescopic devices accordingly.

According to one feature of the invention, the telescopic devices may be linear chain actuators. As such, each of the telescopic devices may comprise a housing fastened to a peripheral post of the base and inside which a chain is wound. When the packing section needs to be pushed, the chain is unwound in the telescopic device and it is this chain that extends said telescopic device in order to push the packing section. Other types of telescopic devices may be used, such as a hydraulic or pneumatic actuator, for example.

According to one feature of the invention, the pushing means is configured to be in contact with the packing section for a gas/liquid separation column in at least one peripheral annular zone. The peripheral annular zone corresponds to a virtual zone at the packing section where the positioning of the pushing means is optimal. The annular zone is said to be peripheral because it is situated close to a peripheral edge of the packing section. Indeed, the frictional forces applied by the wall of the shell are applied at the periphery of the packing section. The end of the telescopic devices is therefore preferably situated facing this peripheral annular zone, and the pushing means that helps distribute the pushing force of the telescopic devices preferably also faces this peripheral annular zone.

According to one feature of the invention, the pushing means has an annular shape, and a radial dimension of the annular shape corresponds to a radial dimension of the peripheral annular zone. The pushing means therefore corresponds to a pushing ring, and the dimensions of this pushing ring are such that it is arranged entirely in contact with the peripheral annular zone. The pushing ring has a diameter smaller than or equal to the diameter of the packing section in order to prevent any mechanical interference with the walls of the shell. The diameter of the pushing ring should be considered here to be the outer diameter, i.e., the largest diameter of said pushing ring. Such a feature ensures that the pushing ring does not extend radially beyond the dimensions of the packing section.

According to one feature of the invention, the insertion device comprises a member for holding the telescopic devices, said holding member connecting the telescopic devices together mechanically. The telescopic devices may be extended over a length of several tens of metres, depending on the length of the shell. Although they are fastened to the peripheral posts and to the pushing means, their high potential length when extended, combined with a high pushing force, may cause the telescopic devices to bend. The holding member stabilises the telescopic devices and tends to keep them aligned with the pushing axis, equidistant from each other. The holding member may, for example, be in the form of a metal structure connecting all of the telescopic devices. The shape of the metal structure depends on the number of telescopic devices; for example, it may be triangular if the insertion device comprises three telescopic devices.

The invention also covers a system for inserting at least one packing section into a cylindrical shell, comprising a load-bearing structure and an insertion device as described previously, the insertion device being carried by the load-bearing structure in such a way that the telescopic devices are able to extend in a horizontal direction. The insertion system as a whole performs additional functions such as that of moving the insertion device. The insertion system allows a plurality of packing sections to be inserted in sequence.

The load-bearing structure can be in the form of a gantry that is able to move in at least one direction while carrying the insertion device gripping hold of a packing section. In order to effect such a movement, the load-bearing structure may be arranged on rails, for example, in order for the movement direction to be as accurate as possible.

As already mentioned, the purpose of the insertion system according to the invention is to insert the packing sections into a shell arranged horizontally. The insertion system is therefore configured in such a way that the telescopic devices are able to extend in a horizontal direction in order to insert the packing sections horizontally.

According to one feature of the invention, the insertion device as a whole is able to move in translation relative to the load-bearing structure. The insertion device may move vertically, for example, independently of the load-bearing structure. This vertical movement is useful, for example, in order to position the insertion device vertically in line with a stack of packing sections, and then lower it in order to grip hold of the packing section arranged at the top of the stack. The vertical movement of the insertion device in relation to the load-bearing structure is also useful for adjusting the position of the gripped packing section in order to position it correctly at the entrance of the shell and thus make it easier to push the packing section into the shell. The relative movement of the insertion device in relation to the load-bearing structure may be achieved, for example, by means of a motor installed on the load-bearing structure and configured to move an element carrying the insertion device along the load-bearing structure.

According to one feature of the invention, the insertion device is able to rotate as a whole relative to the load-bearing structure. The rotation makes it possible, in particular, to pivot the insertion device, with a load-bearing structure that remains stationary, between a position in which the insertion device is arranged vertically in order to grip hold of a packing section on a vertical stack of packing sections, and a position in which the insertion device is arranged horizontally in order to insert the gripped packing section into the shell. The rotation elements therefore need to be configured to allow the insertion device to rotate through approximately 90°, so as to allow the insertion device to pivot between the vertical and horizontal positions referred to above. The relative rotation of the insertion device in relation to the load-bearing structure may be achieved, for example, by means of a motor capable of driving a system of gears rotating the insertion device, or indeed via a chain system or a hydraulic system.

The invention also covers a method for inserting at least one packing section into a cylindrical shell implemented by an insertion system as described previously, comprising:
a step in which the gripping means of the insertion device grip hold of a packing section,
a step of rotating the insertion device as a whole in relation to the load-bearing structure,
a step of moving the insertion system up to the shell by means of the load-bearing structure,
a step of positioning the packing section at an entrance of the shell,
a step of pushing the packing section into the shell by means of a translational movement of the telescopic devices and the pushing means in relation to the base.

The steps of the method are carried out by means of the various aforementioned components of the insertion system. Thus, the gripping step is carried out by means of the gripping means of the insertion device and the means for moving the insertion device in translation in relation to the load-bearing structure, the rotation step by means of the rotation elements installed on the load-bearing structure, the moving step via the load-bearing structure, the positioning step by means of the means for moving the insertion device in translation in relation to the load-bearing structure, and the pushing step by means of the telescopic devices and the pushing means. It should be noted that this is a non-exhaustive list of steps for the correct implementation of the method for inserting packing sections into the shell according to the invention. By way of a non-limiting example, the method according to the invention may include a step of checking the correct positioning of the packing section, once it has been inserted into the shell. This additional step, which in this instance follows the pushing step, consists in checking and recording the correct position of the packing section that has just been inserted, by means of a measuring device accurate to the nearest millimetre.

### BRIEF DESCRIPTION OF THE DRAWINGS

Other features and advantages of the invention will be further disclosed in the description that follows, and in several embodiments provided as non-limiting examples in reference to the appended schematic drawings, in which:

FIG. 1 is a general view of the system for inserting packing sections comprising an insertion device according to the invention, when gripping hold of a packing section,

FIG. 2 is a general view of the system for inserting packing sections, when inserting a packing section into a shell,

FIG. 3 is a detailed view of a telescopic device of the insertion system,

FIG. 4 shows a step of gripping hold of a packing section of a method for inserting packing sections,

FIG. 5 shows a step of rotating the insertion device and moving the insertion system of the method for inserting packing sections,

FIG. 6 shows a step of inserting the packing section of the method for inserting packing sections,

FIG. 7 is a detailed view of a pushing means of the insertion system and a packing section against which the pushing means is intended to be in contact.

### DETAILED DESCRIPTION OF THE INVENTION

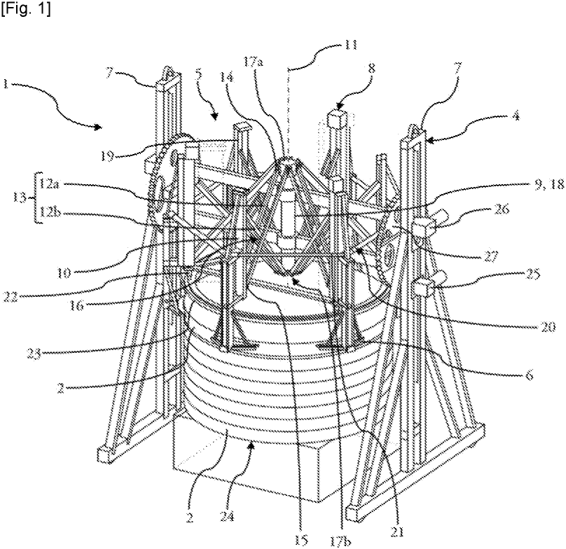

FIG. 1 shows a system 1 for inserting packing sections 2 horizontally into a shell in order to form a gas/liquid separation column. Such separation columns are, for example, cylindrical with a circular or substantially circular cross section. Separation columns may have a main dimension of several tens of metres and a cylindrical cross section of several metres. The packing sections 2 that are to be inserted into these separation columns may have a circular or substantially circular cross section with a diameter of approximately 2.5 metres to 5 metres.

Because the heightwise mechanical space requirement makes the insertion operation impossible when the shell is arranged vertically, said operation is carried out in this instance with the shell positioned horizontally, and the packing sections 2 are also inserted in a horizontal direction.

The system 1 for inserting packing sections 2 according to the invention can be used to carry out a method for inserting said packing sections 2 into the shell, even though the shell is positioned horizontally and may create mechanical stresses as a result. Such an insertion system 1 can be used, in particular, to grip hold of a packing section 2 on a vertical stack 24 of packing sections, as shown in FIG. 1. The insertion system 1 can then be used to perform a rotational movement in order to arrange the packing section 2 facing an entrance of the shell, move up to the entrance of the shell, and then push the packing section 2 to the bottom of the shell or up against another packing section 2 already inserted into the shell, ensuring the packing section 2 is pushed into the shell as smoothly as possible, i.e., with as few jolts as possible.

For this purpose, the insertion system 1 comprises a load-bearing structure 4, and an insertion device 5 arranged on the load-bearing structure 4, and comprising, in particular, gripping means 6 for gripping hold of the packing sections 2. The load-bearing structure 4 is in the form of a gantry comprising two legs 7 between which the insertion device 5 rests. The load-bearing structure 4 may, for example, be mounted on rails in order for the insertion system 1 to be able to perform a linear movement between the stack 24 of packing sections 2 and the shell.

The insertion system 1 further comprises a first motor 25 allowing the insertion device 5 as a whole to move in translation in relation to the load-bearing structure 4. The insertion system 1 also comprises a second motor 26 for actuating a system of gears 27 used to rotate the insertion device 5 as a whole relative to the load-bearing structure 4. This rotation switches the insertion device from a vertical position to a horizontal position, so as to be able to arrange the packing section 2 facing the entrance of the shell as previously mentioned.

The insertion device 5 comprises a base 8 carried by the load-bearing structure 4 and provided with the gripping means 6 allowing the insertion device 5 to grip hold of a packing section 2, regardless of the diameter of said packing section 2. In FIG. 1, there are six gripping means 6.

The base 8 comprises a main post 9 and a plurality of peripheral posts 10 parallel to the main post 9. The main post 9 extends mainly along a main axis 11 passing through the centre or substantially through the centre of the gripped packing section 2. The peripheral posts 10 are arranged circumferentially and at regular intervals around the main post 9. The gripping means 6 mentioned previously are arranged at the peripheral posts 10. The base 8 comprises at least two peripheral posts 10. Advantageously, and as shown in FIG. 1, the base 8 comprises at least six peripheral posts 10. Such a base 8 can be used to grip hold of a packing section 2 with a defined diameter.

Alternatively, the base 8 may be able to be deployed to cover a plurality of diameters of packing sections 2. In order to do so, each peripheral post 10 may be mechanically connected to the main post 9 by two branches 12 forming a pair de branches 13. Each of the two branches 12 comprises a first end 14 connected to the main post 9, and a second end 15 connected to the peripheral post 10. Furthermore, the two branches 12 of the pair of branches 13 intersect each other and are connected at their point of intersection, i.e., substantially at their centre, by a pivot link 16.

The main post 9 comprises two fixed rings 17, each of the fixed rings 17 being arranged at each end portion of said main post 9. The main post 9 comprises a telescopic body 18 that is able to modify a main dimension of the main post 9. Therefore, by modifying the length of the main post 9, the distance between the two fixed rings 17 can be increased or decreased. The length of the main post 9 can be adjusted manually or via a control member not shown here. The telescopic body 18 allows the length of the main post 9 to be modified by extending or retracting at least one of its end portions.

The first end 14 of each branch 12 of the pair of branches 13 connecting the main post 9 to one of the peripheral posts 10 is more particularly connected to one of the fixed rings 17 arranged on the main post 9. Each pair of branches 13 thus comprises a first branch 12a whose first end 14 is connected to a first fixed ring 17a, and a second branch 12b whose first end 14 is connected to a second fixed ring 17b. The second end 15 of the two branches 12 is fastened to the peripheral post 10 and at least one of them may slide along it, for example by means of a guideway 19 formed on one of the faces of the peripheral post 10.

Therefore, when the length of the main post 9 is modified by the telescopic body 18, the distance between the fixed rings 17 and therefore the distance between the first ends 14 of each of the two branches 12 are also modified. Since the branches 12 are connected at a point forming a pivot link 16, this point tends to move towards or away from the main post 9 depending on whether the first ends 14 are moved away from or towards each other. The movement of the telescopic body 18 therefore modifies the inclination of the branches 12 of each of the pairs of branches 13 and thus modifies the radial distance between the main post 9 and the peripheral posts 10.

The base 8 therefore has the function of modifying a radial distance between the main post 9 and each of the peripheral posts 10, the gripping means 6 for gripping hold of the packing section being arranged on said peripheral posts 10. The gripping means 6 may thus be moved apart in order to allow them to engage around packing sections 2 of different diameters. The longer the main post 9, the further apart the fixed rings 17 are from each other, and the closer the peripheral posts 10 are to the main post 9, adapting the insertion device 5 to a small packing section 2 diameter. Conversely, the shorter the main post 9, the closer the fixed rings 17 are to each other, and the further the peripheral posts 10 are from the main post 9, adapting the insertion device 5 to a large packing section 2 diameter. The base 8 as it has just been disclosed therefore allows the insertion device 5 to be adapted to a plurality of diameters of packing sections 2 and shells.

Once the desired radial distance has been established, it can be fixed using a locking means 20. The locking means 20 may, for example, be associated with a plurality of extendable rods 21 extending between two adjacent peripheral posts 10, as shown in FIG. 1.

With a base 8 that can be deployed as described previously, the gripping means 6 may be adjusted to grip hold of the packing section 2 correctly, regardless of the diameter of the latter.

Because the packing section 2 is gripped by its edge, combined with the fact that the packing sections 2 are cylindrical with a circular or substantially circular cross section, the gripping means 6 is in the shape of an arc of a circle, so that the whole of the gripping means 6 intended to be in contact with the packing section 2 conforms to a radius of curvature thereof. The packing section 2 is therefore gripped more easily and stably. In order for the gripping means 6 to grip hold of the packing section 2 in an optimal manner, the curvature of the arc of a circle formed by the gripping means 6 can be adjusted to fit packing sections 2 of all diameters.

Once the gripping means 6 have gripped hold of the packing section 2, the latter may be controlled individually in relation to each other in order to push on a specific point of the packing section 2 and deform the latter locally. Such local deformation may be recommended when there is a differential in shape between the packing section 2 and the shell into which the packing section 2 is intended to be inserted. The local deformation therefore allows the shape of the packing section 2 to be modified slightly so that it can then be inserted more easily into the shell.

At least two of the peripheral posts 10 are provided with telescopic devices 22. The telescopic devices 22 may be arranged on a peripheral post 10 also provided with a gripping means 6, the essential point being that none of these components interfere with each other mechanically. The telescopic devices 22 allow the packing section 2 to be pushed once it has been put in place facing the shell. This pushing operation is implemented as soon as the gripping means 6 have been controlled to release the packing section 2. The telescopic devices 22 extend in order to push the packing section 2 to the end of the shell, regardless of the length of the latter. If one or more packing sections 2 have already been inserted into the shell, the telescopic devices push the packing section 2 until it is in contact with the packing section 2 inserted previously. The telescopic devices 22 may be integrated into the base 8 described previously. In FIG. 1, since the insertion device 5 is gripping hold of a packing section 2 from the stack 24, the telescopic devices 22 are therefore retracted.

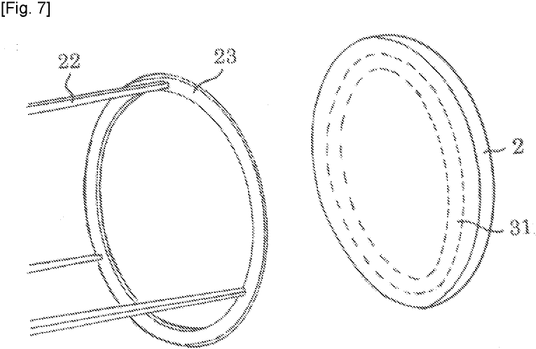

In order to insert the packing section 2 into the shell in a uniform manner, with a minimum of jolts, the insertion device 5 comprises a pushing means 23 fastened to the end of each telescopic device 22, as shown more particularly in FIG. 7, this pushing means being intended to be in direct contact with the packing section 2 during insertion. The pushing means 23 mechanically distributes the forces applied by each of the telescopic devices 22 by pressing on the whole rim of the packing section 2, so as to prevent the forces from being localized only at the end of the telescopic devices 22. The pushing means 23 therefore helps prevent damage to the inserted packing section 2 caused by a localized pushing force. When the telescopic devices 22 are retracted, the pushing means 23 is arranged in the vicinity of the peripheral posts 10.

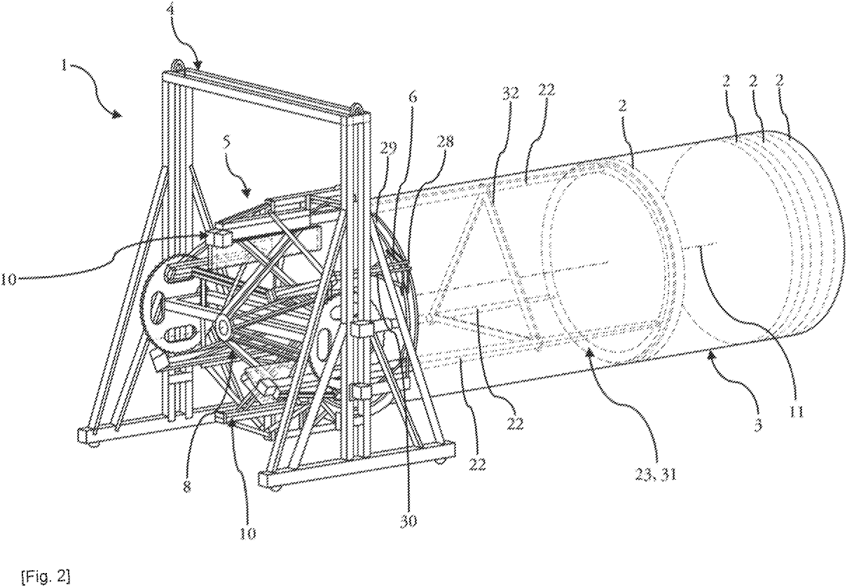

FIG. 2 shows the insertion system as shown in FIG. 1 but during a step of inserting the packing section 2 into the shell 3. In FIG. 2, the telescopic devices 22 are therefore extended. In FIGS. 1 and 2, the insertion device 5 comprises six peripheral posts 10, three of which are provided with telescopic devices 22. The telescopic devices 22 are distributed at regular intervals around the main axis 11.

The insertion system 1 is structured in such a way that the telescopic devices 22 can be extended in the horizontal direction, in order to carry out the step of insertion into the shell 3 arranged horizontally. In other words, the telescopic devices 22 are suitable for being deployed parallel to the main axis 11 and to an axis of extension of the peripheral posts 10.

It can also be seen in FIG. 2 that at least two peripheral posts 10 each comprise a hook 28. When the insertion device 5 is arranged near the shell 3 in order to then insert a packing section 2 into it, the hooks 28 close around the shell 3, for example around a flange 29 that extends circumferentially around the shell 3 at the end of the shell 3 into which the packing sections 2 are inserted. The hooks 28 therefore mechanically hold the shell 3 facing the insertion device 5, including when the packing section 2 is being inserted into the shell 3. The presence of these hooks 28 provides a sufficient counterweight to retain the shell 3 despite the forces applied to it when the packing sections 2 are being inserted. The hooks 28 therefore dispense with the need for a bulky counterweight arranged to the rear of the shell 3 to prevent it from moving while the packing section 2 is being pushed.

In order to be able to close around the flange 29 of the shell 3, the hooks 28 need to extend along each of the peripheral posts 10, beyond the gripping means 6 also carried by the peripheral posts 10. This extension may create a mechanical impediment when the gripping means 6 are gripping hold of a packing section 2 on the stack of packing sections, as shown in FIG. 1, particularly when the last packing section 2 of the stack is being gripped, as the hooks 28 may then hit the ground. To overcome this, each of the hooks 28 is mounted on a retractable actuator 30 in order to retract the hooks 28 and prevent any mechanical constraint associated with a deployed hook 28. The hooks 28 are therefore able to move between a retracted position, in particular when the insertion device 5 is positioned vertically to grip hold of the packing sections 2, and an extended position allowing the insertion device 5 to be fastened to the shell 3 when the gripped packing section 2 is held at the end of the shell 3. When the hooks 28 are in the deployed position, they are configured to prevent any mechanical interference with the gripping means 6 arranged on the same peripheral post 10. In order to prevent said mechanical interferences, the hooks 28 may be a particular shape and/or retract and extend in a pivoting manner around the peripheral post 10 in question, pivoting away from the main post in order not to come into contact with the gripping means 6.

In order to insert packing sections 2 that may reach considerable diameters, each of the telescopic devices 22 has a pushing force of at least 1 ton. This pushing force is distributed over the whole rim of the packing section 2 by means of the pushing means 23.

The telescopic devices 22 are deployed when the packing section 2 is positioned facing the entrance of the shell 3. When the insertion of the packing section 2 begins, the pushing means 23 is moved by the extending of the telescopic devices 22 and comes into contact with the packing section 2. The zone of contact of the pushing means 23 at the packing section 2 corresponds at least to a peripheral annular zone 31 provided on the pushed packing section 2. The peripheral annular zone 31 therefore faces a periphery of the packing section 2, i.e., in the vicinity of an edge of the packing section 2. The dimensions of the pushing means 23 are such that the pushing means 23 do not extend radially beyond the diameter of the pushed packing section 2, in order not to interfere mechanically with a wall of the shell 3. It is therefore understood that the peripheral annular zone 31 lies entirely within the area of a face of the packing section 2, corresponding to the face in contact with the pushing means 23.

When the packing section 2 is being pushed, the force applied by the telescopic devices 22, and by analogy by the pushing means 23, is preferably located at the periphery of the packing section 2, because it is at the periphery that the forces counteracting the pushing occur, in particular the frictional forces between the packing section 2 and the walls of the shell 3. The pushing carried out at the peripheral annular zone 31 therefore makes it possible to compensate for the frictional forces applied to the packing section 2 when it is being inserted into the shell 3. The compensation for frictional forces is particularly effective with the insertion device 5 according to the invention because the pushing means 23 is arranged as close as possible to the location of these frictional forces. As shown in FIG. 2, the pushing means 23 advantageously has an annular shape whose the radial dimension corresponds to the dimension of the peripheral annular zone 31 of the packing section 2.

If the base 8 is configured to be deployed radially and to adapt to packing sections 2 of different diameters, several pushing means 23 of different dimensions are designed and the appropriate pushing means 23 is installed after determining the radial distance between the main post and the peripheral posts 10.

Despite the distribution of the telescopic devices 22 at regular intervals and the presence of the pushing means 23, a frictional force applied to the packing section 2 that is being inserted may be more intense locally. This localized frictional force may be due to the horizontal position of the shell 3 and/or of the packing section 2. Indeed, gravity may cause the packing section 2 to press harder against the wall of the shell 3, thus giving rise to asymmetry in the resulting forces where the packing section 2 comes into contact with the shell 3. Other factors that generate a localized frictional force may also come into play, such as the surface condition of the wall of the shell 3 or the surface condition of the edge of the packing section 2, for example. In order to balance the pushing force, each telescopic device 22 may be controlled individually in order to intensify one or another of the pushing forces in such a way as to compensate for a high local frictional force. In order to detect these local frictional forces, each end of each telescopic device 22 may for example comprise a resistance sensor measuring the frictional forces and therefore capable of detecting a high frictional force.

When the telescopic devices 22 extend to push the packing section 2 into a shell 3 of significant length, for example several tens of metres long, the telescopic devices 22 extend until they reach a considerable length which may prove detrimental to their stability. The insertion device 5 may therefore comprise a holding member 32 connected to all of the telescopic devices 22 and arranged in such a way as to be substantially equidistant from the pushing means 23 and the entrance of the shell 3. The role of the holding member 32 is to maintain the position of each of the telescopic devices 22 and the distance between each of them. The holding member 32 therefore helps distribute the forces applied to the packing section 2 that is being inserted. The holding member 32 also ensures the stability of the telescopic devices 22, by preventing them from potentially bending in the event that said telescopic devices 22 are extended to a considerable length. As shown in FIG. 2, the holding member 32 has a triangular shape in order to keep three telescopic devices 22 spaced apart at equal distances about the main axis 11. However, the shape of the holding member 32 may vary depending on the number of telescopic devices 22 included in the insertion device 5. In a variant not shown here, the holding member 32 may comprise a set of rollers, each arranged in the continuation of the branches of the holding member, beyond the telescopic devices, which are respectively in contact with the inner face of the peripheral wall of the shell. The purpose of this is to provide continuous guidance of the holding member inside the shell when the telescopic devices are being extended and a packing section inserted. This continuous guidance, through contact between at least one of the rollers and the shell, helps facilitate the insertion process despite the weight of the assembly formed by the telescopic arms and the pushing means 23, which could cause the assembly to move out of alignment. Alternatively, or additionally, the pushing means may also comprise one or more rollers arranged at the periphery in order to be in contact with the inner face of the tubular wall of the shell when the packing sections are being inserted into the shell.

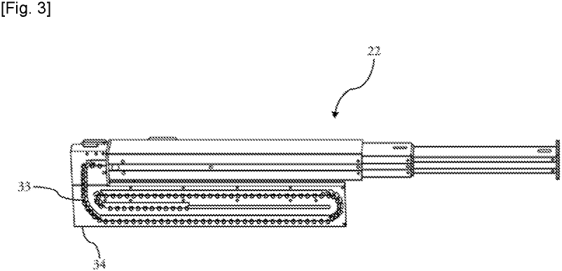

FIG. 3 is a detailed view of a telescopic device 22 integrated into the insertion device described previously. The telescopic device 22 may, for example, be a linear chain actuator. In other words, the telescopic device 22 comprises a chain 33 wound up inside a housing 34 when said telescopic device 22 is retracted.

When the telescopic devices 22 need to be extended, the chain 33 unwinds and becomes rigid inside the telescopic device 22 in order to extend it. The chain 33 unwinds as long as the telescopic device 22 can apply its pushing force to the packing section. Once the packing section has been inserted to the bottom of the shell or up against another previously inserted packing section, the chain 33 winds up inside the housing 34 in order to retract the telescopic device 22. The telescopic devices 22 of the insertion device are retracted simultaneously so that the pushing means can be withdrawn from the shell without mechanical interference.

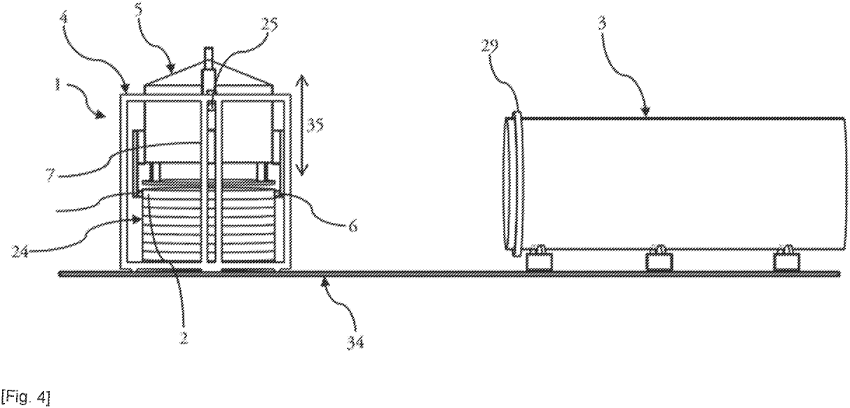

FIGS. 4 to 6 are schematic views of an example of how the method for inserting a packing section 2 according to the invention is performed.

As described previously, it is the insertion system 1 as a whole, i.e., the insertion device 5 and the load-bearing structure 4, that allows the insertion method to be implemented. FIG. 4 therefore shows, in particular, a step of gripping a packing section 2 on the vertical stack 24 of packing sections 2. For this purpose, the insertion system 1 as a whole may move up to the stack 24 of packing sections, for example by means of rails 34, as mentioned previously.

The insertion device 5 as a whole is able to move in translation 35 in relation to the load-bearing structure 4, for example moving vertically in translation along the legs 7, i.e., parallel to said legs 7. This translational movement 35 may be effected, for example, by the first motor 25 actuated remotely. This translational movement 35 is used, for example, so that the insertion device 5 reaches the top of the vertical stack 24 of packing sections 2 and lies above it, as shown in FIG. 4. Once this has been achieved, and once the load-bearing structure 4 is arranged around the vertical stack 24 of packing sections 2, the translational movement 35 allows the insertion device 5 to be moved towards the stack 24 of packing sections 2 in order to grip hold of the packing section 2 at the top of said stack 24 via the gripping means 6. Once a packing section 2 has been gripped, the insertion device 5 is moved vertically once more in order to lift the gripped packing section 2.

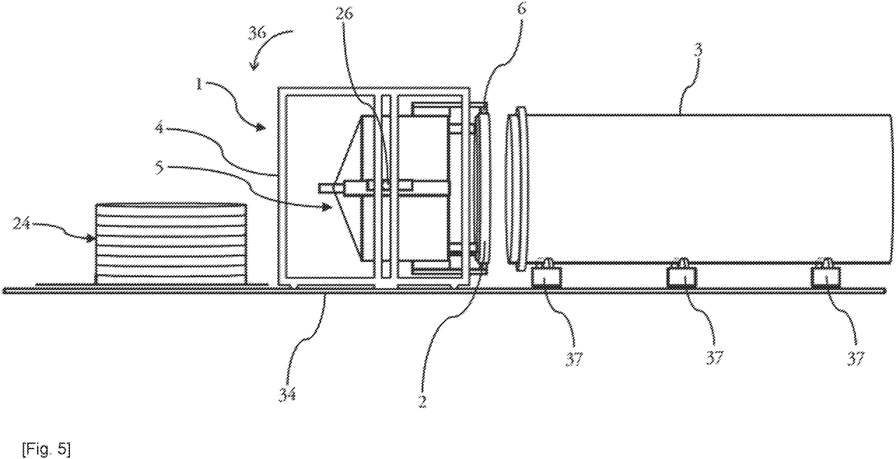

FIG. 5 shows a step of rotating the insertion device 5 and a step of moving the insertion system 1 up to the shell 3. These two steps are carried out after a packing section 2 has been gripped by the gripping means 6. In order to carry out the step of rotating the insertion device 5 in relation to the load-bearing structure 4, the insertion device 5 comprises rotation means, which rotate the insertion device 5 by 90° or substantially 90° in relation to the load-bearing structure 4, in this instance via the system of gears shown in FIG. 1. The second motor 26 may be carried by the load-bearing structure 4 and controlled in such a way that the motor output shaft actuates the system of gears and therefore the rotation 36 of the insertion device 5 in relation to the load-bearing structure 4. This rotation device driven by the second motor 26 therefore allows the insertion device 5 to pivot between a first position referred to as the vertical position, allowing the packing sections 2 on the stack 24 of packing sections 2 to be gripped, as shown in FIG. 4, and a second position referred to as the horizontal position, in order to arrange the gripped packing section 2 facing the horizontal shell 3, as shown in FIG. 5.

The load-bearing structure 4 can then move, while carrying the insertion device 5, in order to move the gripped packing section 2 towards the shell 3 so as to insert it into same, for example by means of the rails 34 as mentioned previously. The shell 3 may be arranged on supports 37 in order to stabilize it.

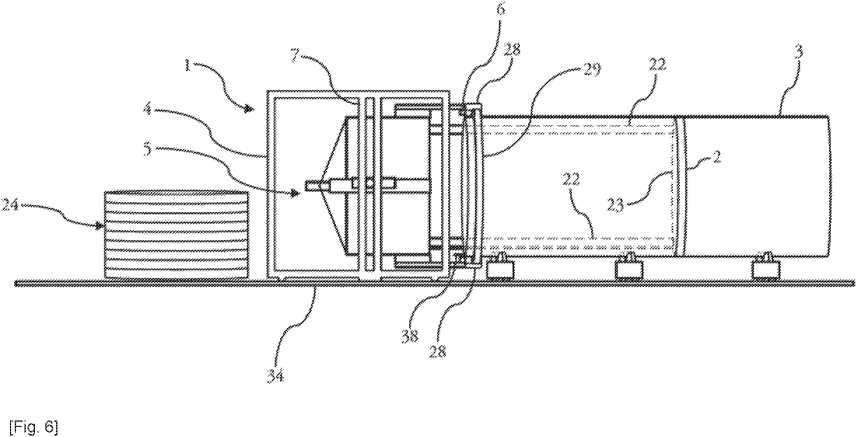

FIG. 6 shows the step of positioning the insertion device 5 at the entrance of the shell 3 and the step of pushing the packing section 2 into the shell 3. In order to position the packing section 2 correctly at the entrance of the shell 3, the vertical position of the insertion device 5 may be adjusted via the vertical translational movement along the legs 7 of the load-bearing structure 4 in order for the gripped packing section 2 to face the entrance of the shell 3 in a perfectly aligned manner. Having achieved this, the hooks 28 close around the flange 29 of the shell 3 in order to hold the insertion device 5 facing the entrance of the shell 3.

The pushing step begins after the gripping means 6 have released the packing section 2. Once the gripping means 6 have released the packing section 2 and before the telescopic devices 22 are extended to insert the packing section 2, the latter may, for example, rest on a holding support 38 in order for the packing section 2 to remain correctly positioned facing the entrance of the shell. The telescopic devices 22 are then extended in order for the pushing means 23 to insert the packing section 2 into the shell 3, as previously described. Once the packing section 2 has been inserted, the telescopic devices 22 may be retracted, and the insertion system 1 may once more move to pick up the next packing section 2. The insertion method then starts again from the gripping step described in FIG. 4.

Naturally, the invention is not restricted to the examples that have been just been described, and numerous refinements may be made to these examples without departing from the scope of the invention.

The invention as just described achieves its stated objective and provides a device for inserting a packing section horizontally into a shell comprising a pushing means moved by telescopic devices and limiting the friction applied to the inserted packing section. Variants not described here may be implemented without departing from the scope of the invention provided that, in accordance with the invention, they comprise an insertion device according to the invention.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

1. A device for inserting at least one packing section for a gas/liquid separation column into a cylindrical shell, the device comprising:
a base provided with gripping means configured to grip hold of a packing section and arranged at regular intervals around a main axis;
at least two telescopic devices secured to the base; and
at least one pushing means secured to one end of each of the two telescopic devices, the telescopic devices being configured to extend and cause the pushing means to move.

2. The insertion device according to claim 1, wherein the telescopic devices are arranged at regular intervals around the main axis.

3. The insertion device according to claim 1, wherein the telescopic devices and the gripping means are arranged on a peripheral post of the base.

4. The insertion device according to claim 1, wherein each telescopic device has a pushing force of at least 1 ton.

5. The insertion device according to claim 1, wherein the telescopic devices are controlled individually.

6. The insertion device according to claim 1, wherein the telescopic devices are linear chain actuators.

7. The insertion device according to claim 1, wherein the pushing means is configured to be in contact with the packing section in at least one peripheral annular zone.

8. The insertion device according to claim 1, wherein the pushing means has an annular shape, a radial dimension of the annular shape corresponding to a radial dimension of the peripheral annular zone.

9. The insertion device according to claim 1, further comprising a member for holding the telescopic devices, said holding member connecting the telescopic devices mechanically.

10. A system for inserting at least one packing section for a gas/liquid separation column into a cylindrical shell, comprising a load-bearing structure and an insertion device according to claim 1, the insertion device being carried by the load-bearing structure in such a way that the telescopic devices are able to extend in a horizontal direction.

11. The system according to claim 10, wherein the insertion device as a whole is able to move in translation relative to the load-bearing structure.

12. The system according to claim 10, wherein the insertion device as a whole is able to rotate relative to the load-bearing structure.

13. A method for inserting at least one packing section for a gas/liquid separation column into a cylindrical shell, performed by an insertion system according to claim 10, the method comprising the steps of:
using the gripping means of the insertion device to grip hold of a packing section;
rotating the insertion device as a whole in relation to the load-bearing structure;
moving the insertion system up to the shell by means of the load-bearing structure;
positioning the packing section at an entrance of the shell;
pushing the packing section into the shell by means of a translational movement of the telescopic devices and the pushing means in relation to the base.
